(19) United States
(12) Patent Application Publication
(10) Pub. No.: US 2016/0238365 A1
(43) Pub. Date: Aug. 18, 2016

(54) Crown Molding Protractor

(71) Applicants: Barry Douglas Wixey, Sanibel, FL (US); Shi Jian, Guilin (CN); Li Guang Jin, Guilin (CN)

(72) Inventors: Barry Douglas Wixey, Sanibel, FL (US); Shi Jian, Guilin (CN); Li Guang Jin, Guilin (CN)

(21) Appl. No.: 14/996,190

(22) Filed: Jan. 14, 2016

Related U.S. Application Data
(60) Provisional application No. 62/125,093, filed on Jan. 14, 2015.

(51) Int. Cl. G01B 3/56; E04F 19/02; E04F 21/00

(52) U.S. Cl. CPC G01B 3/563; E04F 21/00; E04F 19/02

(57) ABSTRACT

A digital protractor is provided for measuring spring and wall angles and determining and effecting bevel and miter angle adjustments of a miter saw to adjoining pieces of trim in accordance with the measured spring and wall angles. The protractor includes a pair of pivotally interconnected arms. At least one sensor is attached to one of the arms and a digital readout is secured to the other arm. The readout includes means for determining the bevel and miter angles such that the protractor can be set to those angles to properly adjust the miter saw in accordance with the calculated angles.

### RELATED APPLICATION

This application claims the benefit of U.S. Provisional Patent Application No. 62/125,093 filed Jan. 14, 2015.

### FIELD OF THE INVENTION

This invention relates to a protractor that can be used to make measuring, cuffing and installing crown molding and other trim quicker, easier and more accurate.

### BACKGROUND OF THE INVENTION

Crown molding and other types of decorative molding and trim can be extremely difficult, tedious and frustrating to install. Precisely mitered and beveled angles are typically required where adjoining pieces of molding or trim meet at inside and outside corners of adjacent walls. Forming these angles, especially when crown molding is involved, requires that complex cuts be made in the adjoining pieces of molding typically using a compound miter saw. Wall and spring angles must be measured, bevel and miter measurements calculated and the installer's saw precisely adjusted to achieve an accurate fit. This is traditionally a tedious, time consuming and highly unreliable process. Oftentimes, the installer uses trial and error, which can result in uneven and unattractive joints in the molding. Time and expense can be wasted attempting to correct poor results and many times a desired neat and attractive appearance is never achieved.

Precalculated crown molding tables and software have been developed to assist the installer and facilitate the molding installation process. Nonetheless, using such resources remains a time consuming, tedious and often inaccurate process. The results are still apt to be unsatisfactory particularly if an inexperienced installer is involved,

Recently, protractors have been developed for measuring wall angles and spring angles, which are needed in order to derive miter and bevel angle adjustments for the installer's miter saw. However, no existing protractors are available that can be used to engage and adjust the installer's saw according to the derived miter and bevel angles. Existing tools merely calculate desired bevel and miter angles and cannot be used to directly guide the angular adjustments of the cutting saw. Such a feature would improve the speed and accuracy of such adjustments.

### SUMMARY OF THE INVENTION

It is therefore an object of the present invention to provide a molding protractor that permits the user to quickly and accurately calculate spring and wall angles and which also facilitates and guides the adjustment of miter and bevel angles of a cutting saw so that trim and molding may be cut more quickly and accurately at required angles.

It is a further object of this invention to provide a molding and trim protractor employing a processing and display unit that accurately calculates and displays spring and wall angles as well as related miter and bevel angles so that abutting pieces of trim and molding may be cut and fitted more evenly, quickly and efficiently.

This invention features a molding and trim protractor having a pair of pivotally interconnected upper and lower arms. Each arm has at least one engagement edge extending along the arm. An electronic sensor is secured to one of the arms and a digital readout device is secured to the other arm for operatively cooperating with the electronic sensor to measure and display angular displacement between adjoining walls engaged by the respective arms. The sensor may also be used to measure spring angles or a second sensor may be used for that measurement. There are also means for calculating corresponding miter and bevel angles from the measured spring and wall angles and displaying the calculated spring and wall angles. The protractor is adjusted according to the calculated bevel and miter angles and engaged with a miter saw to adjust the saw according to the calculated angles.

### BRIEF DESCRIPTION OF THE DRAWINGS

Other objects, features and advantages will occur from the following description of a preferred embodiment and the accompanying drawings, in which:

FIG. 1 is a top plan view of an electronic crown molding protractor in accordance with this invention;

FIG. 2 is a schematic elevational view of the principal electronic components and a preferred readout display used in the protractor;

FIG. 3 is an elevational view of a preferred readout including both the display and the operating buttons and specifically indicating activation of the unit;

FIG. 4 is an elevational view of the readout being set to the spring angle measurement mode;

FIG. 5 is an elevational view of the device being utilized to measure the spring angle of a piece of crown molding;

FIG. 6 is a plan view of the protractor being used to measure an outside wall angle;

FIG. 7 is a plan view of the device being used to measure an inside wall angle;

FIG. 8 is an elevational view of the readout displaying measured spring and wall angles;

FIG. 9 is an elevational view of the readout displaying the calculated bevel angle;

FIG. 10 is an elevational view depicting adjustment of the protractor in accordance with the calculated bevel angle;

FIG. 11 is a perspective view of the protractor being engaged with a miter saw to set the calculated bevel angle;

FIG. 12 is an elevational view of the readout being operated to calculate and display the miter angle for the piece of trim to be cut;

FIG. 13 is an enlarged view of the display in the miter calibrating mode and the graphic and numeric information contained therein;

FIG. 14 is an elevational view of the protractor being adjusted in accordance with the calculated miter angle;

FIG. 15 is a perspective view of the adjusted protractor being engaged with a miter saw to adjust the miter angle of the saw;

FIG. 16 is a perspective view of an alternative dual sensor protractor in accordance with this invention;

FIG. 17 is a top view of the dual sensor protractor;

FIG. 18 is a rear elevational view of the dual sensor protractor;

FIG. 19 is a front elevational view of the dual sensor protractor;

FIG. 20 is a cross sectional view taken along line A-A of FIG. 17;

FIG. 21 is a bottom perspective view of the dual sensor protractor being used to measure a wall angle;

FIG. 22 is a bottom perspective view of the dual sensor protractor being used to measure a spring angle;

FIG. 23 is a perspective view illustrating the dual sensor protractor with the rotating arm positioned in the bevel adjustment mode;

FIG. 24 is an elevational view of the graphic display of the dual sensor protractor indicating required bevel angle adjustment;

FIG. 25 is a perspective view of the adjusted protractor being used to adjust the bevel of a miter saw.

FIG. 26 is a perspective view of the dual sensor protractor with the rotating measurement arm positioned in the miter adjustment mode;

FIG. 27 is an elevational view of the dual sensor protractor display in the miter adjustment mode;

FIG. 28 is a perspective view illustrating the miter adjusted dual sensor protractor engaged with a miter saw being used to adjust the miter angle of that saw to produce a corresponding cut;

FIG. 29 is an elevational view of the graphic display used in the dual sensor protractor and particularly indicating the digital indicia relating to preferred placement of the trim on the miter saw after miter and bevel angle adjustments have been made to the saw;

FIG. 30 is a perspective view of the protractor with the rotating arm positioned for properly placing the second piece of trim on a miter saw;

FIG. 31 is an elevational view of the graphical display indicating preferred placement to the second piece of trim relative to the saw after bevel and miter angle adjustments have been made;

FIG. 32 is a perspective view of the dual sensor protractor engaged with a miter saw for properly positioning a second piece of trim on the saw to be cut according to calculated bevel and miter angles;

FIG. 33 is a perspective view of a pair of adjoining pieces of trim that have been interengaged at a corner after being respectively cut but a saw that has been adjusted using the protractor of this invention.

### DETAILED DESCRIPTION OF PREFERRED EMBODIMENTS

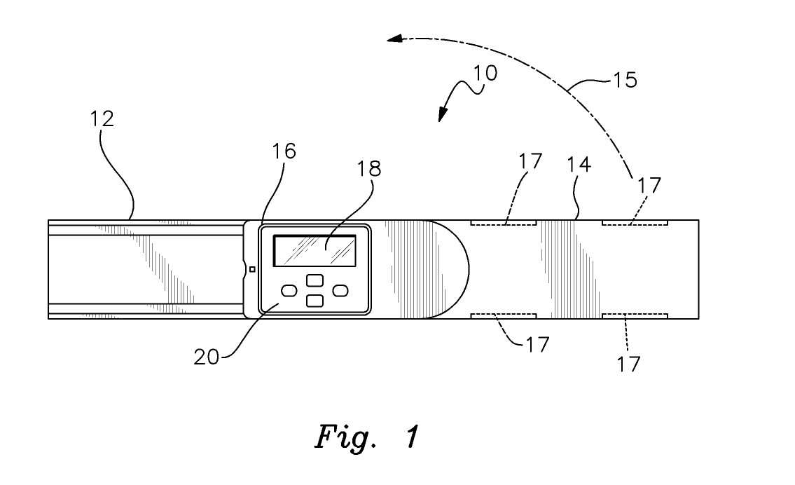

There is shown in FIG. 1 a protractor 10 that is used for both measuring both the spring and wall angles and for calculating and setting the corresponding miter and bevel angles needed to install adjoining pieces of molding and trim in crown molding and other carpentry applications. The particular environment and trim or molding application in which protractor 10 is employed are not limitations of this invention. Nonetheless, the protractor is especially useful for determining and setting the complex saw cut angles that must be formed in adjoining pieces of molding or trim used in crown molding and analogous applications where adjoining walls meet at a corner. As used herein, the terms “trim” and “molding” should be understood as being used interchangeably. Complex angles in adjoining pieces of trim are often required when those pieces meet at an inside or outside corner of a room or otherwise where two adjoining walls meet. The present invention enables both the wall angle and the spring angle between the ceiling and the walls to be measured quickly, easily and accurately and may also be used to quickly and accurately set the corresponding bevel and miter angles required for a compound miter saw to cut the adjoining pieces of trim. Unlike any previous devices, the protractor not only calculates and conveys information in a graphically intuitive and easy to understand fashion, it may also be adjusted, set and directly engaged with the miter saw to rapidly and efficiently effect accurate saw adjustments.

As shown in FIG. 1, protractor 10 features a pivotally interconnected pair of substantially congruent upper and lower arms 12 and 14, respectively. A digital readout comprising a digital angle gauge 16 is mounted to upper arm 12. The digital readout utilizes conventional capacitive measurement technology, for example as described in U.S. Pat. Nos. 7,726,034 and 7,934,322 (hereinafter U.S. Pat. Nos. '034 and '322) the disclosures of which are incorporated herein by reference. The plate-like upper and lower arms 12 and 14 are pivotally interconnected in a manner that allows the arms to pivot in a generally laminar fashion relative to one another such that the arms 12 and 14 are generally superposable with respect to one another. Again, see the operation disclosed in the above referenced patents. One or both of arms 12 and 14 may carry magnets 17 that are typically mounted in longitudinal grooves formed in the respective side edges of the arms. In the version shown herein, only arm 14 carries magnets 17. In alternative embodiments, magnets may be formed in both arms or in only one edge of one or both arms. In other embodiments, magnets may be omitted entirely. The magnets allow the arms to be engaged with and attached to a miter saw during subsequent angular adjustment of the saw. See U.S. Pat. Nos. 034 and '322.

As further depicted in FIG. 1, readout 16 includes an LCD display panel 18 and a set of operating buttons 20, the function of which will be described more fully below. More particularly, as illustrated in FIG. 2, readout 16 features internal components including, but not limited to a capacitive disk sensor 22 that is operatively interengaged with a conventional circuit board, not shown, so that the angle between protractor arms 12 and 14 may be measured in a manner to that analogous to that described in U.S. Pat. Nos. '034 and '322. Various alternative sensor devices (e.g. solid state, resistance, laser and light sensors may be employed within the scope of this invention. The measured angular output is delivered to a processor 24 powered by batteries 26. The processor may comprise various known types of microprocessors and other electronic processing units and is programmed to perform the calculations described below. The processor performs calculations and delivers outputs to display panel 18 in accordance with instructions provided by the user through push button control panel 20.

Display 16 includes various numeric and graphic designations relating to adjoining trim pieces and corresponding angular adjustments of a miter saw required for forming proper cuts in the adjoining trim pieces before they are installed as crown molding or otherwise. In particular, display 16 includes LCD digits reflecting measured spring and wall angles and both calculated and adjusted bevel and miter angles. A graphic representation 30 of the pieces of trim to be cut are also represented. The display also includes a graphic representation of the miter saw fence as well as the designations “SPRING SET”, “SET WALL”, “RIGHT PIECE” and “LEFT PIECE” which are explained more fully below. Various other digital representations, as disclosed below and in pending U.S. patent application Ser. No. 14/837,469, may also appear in display 18.

The push button control panel 20 includes respective buttons labeled “ON/OFF”, “SET”, “HOLD LEFT” and “HOLD RIGHT”. The operation of these buttons in conjunction with display 16 is described more fully below.

### Operation of Protractor 10

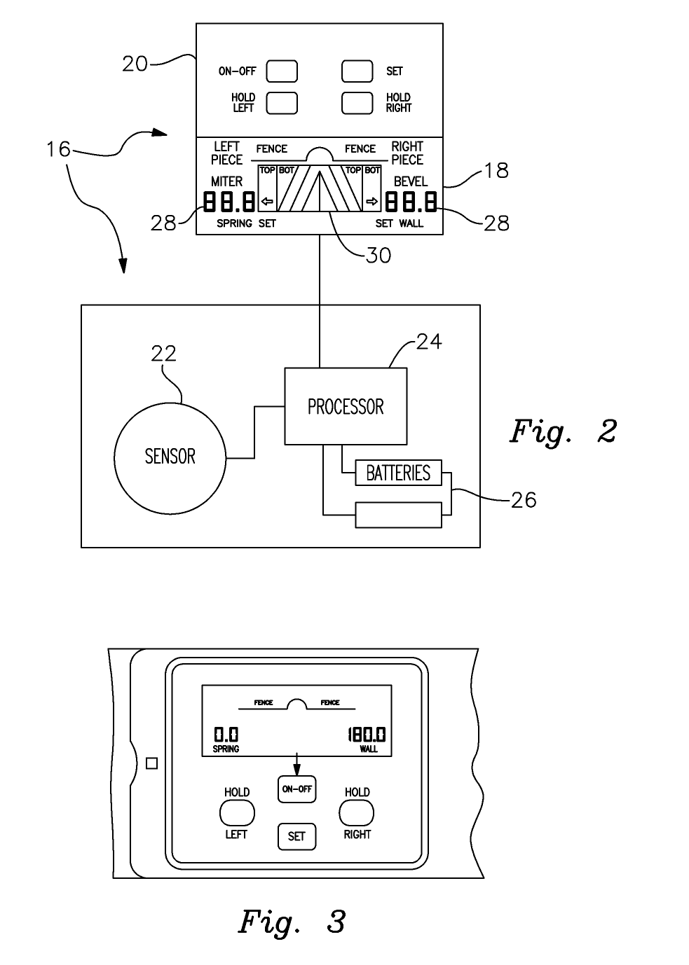

Batteries 26 are installed in readout 16. The ON/OFF button of panel 20 is pressed to activate protractor 10 and enter the measuring mode, FIG. 3. In this mode, the digital numerical displays are activated for indicating the spring angle (“SPRING” and the wall angle (“WALL”). The wall measurement should be 180.0° when protractor 10 is opened onto a flat surface such that arms 12 an 14 are aligned. If the measuring mode is not shown, it may be activated by pressing the “HOLD LEFT” and “HOLD RIGHT” buttons simultaneously.

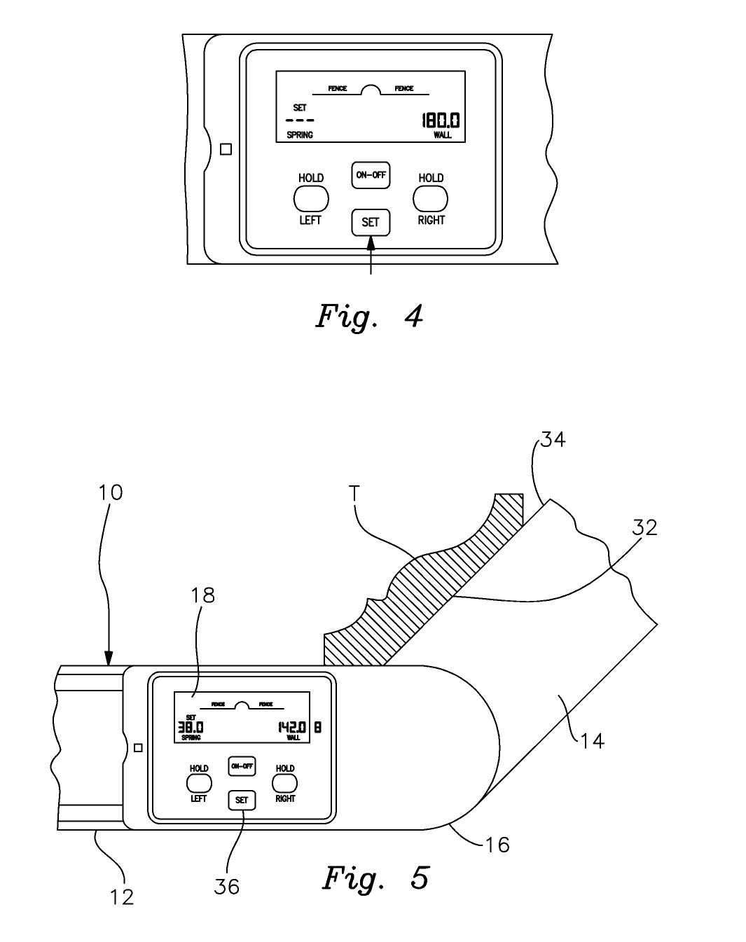

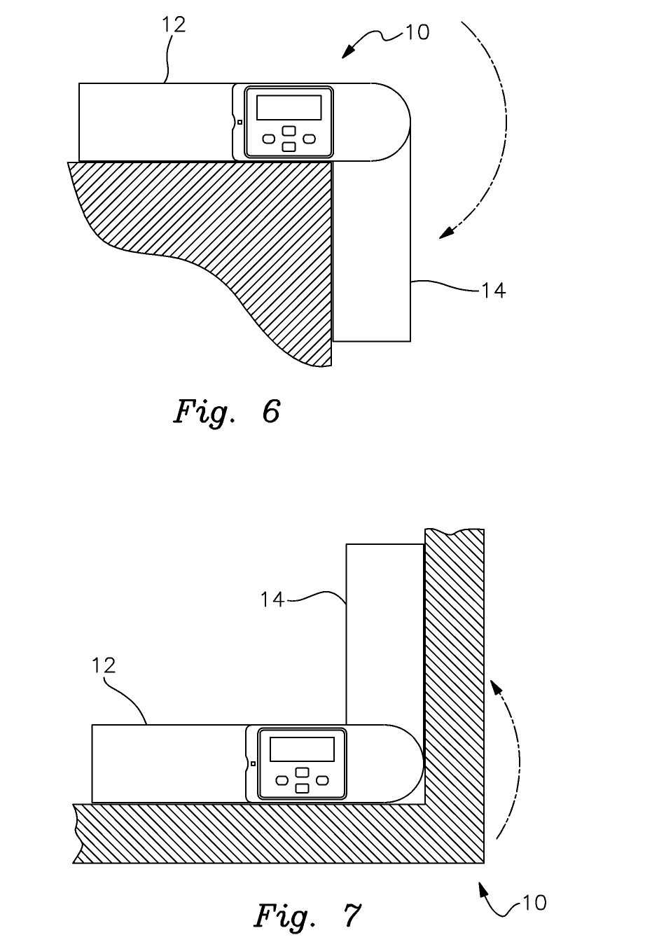

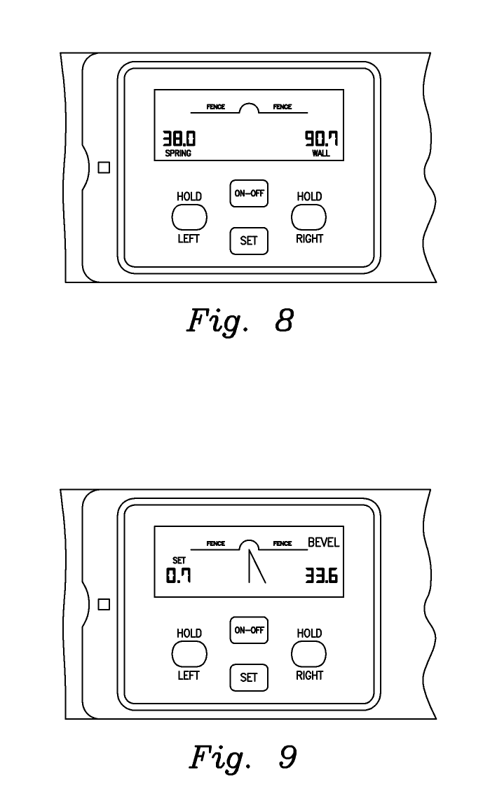

As shown in FIG. 4, the user next presses and holds the “SET button to enter the spring angle setting mode. This causes the digital destination “SET” to flash on the display 16. The “SPRING” angle is blank. As shown in FIG. 5, the user then engages a representative piece of trim T with protractor 10. Specifically, the bottom of the trim is flushly engaged with fixed arm 12 and the pivoting arm 14 is angularly rotated relative to readout 16 until its upper edge 34 flushly interengages angled interior edge 32 of trim T. This causes sensor 22, FIG. 2, to measure the spring angle of trim T, which measurement is processed and displayed on display screen 18 of readout 16. In this example, a spring angle of 38.0° is measured. The user then presses “SET” button 36 to lock in the measured spring angle. This also causes readout 16 to enter the wall measuring mode. The angle of either an exterior or interior wall corner may then be measured by angularly rotating arm 14 relative to arm 12, as indicated in FIGS. 6 and 7 respectively. For example, as shown in FIG. 8, an inside corner is measured and displayed as having an angle of 90.7° degrees. At the same time, the previously measured spring angle of 38.0° remains displayed.

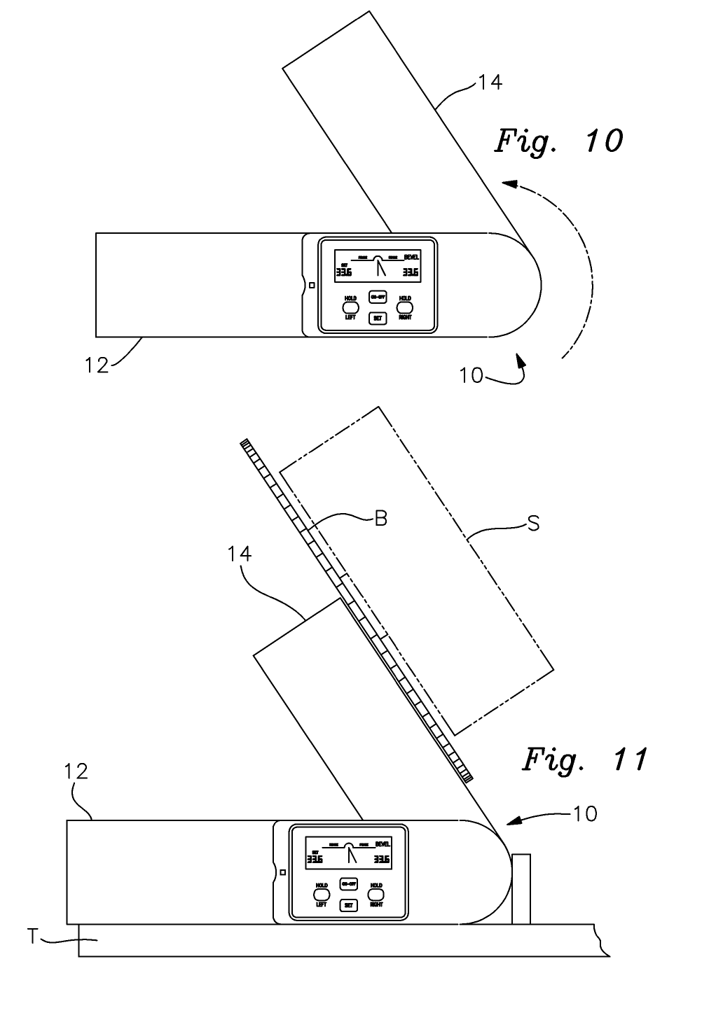

As shown in FIG. 9, the user next presses either the “HOLD LEFT” or “HOLD RIGHT” button to enter the bevel setting mode. Processor 24, FIG. 2, is programmed to determine the proper bevel angle corresponding to the measured spring and wall angles for either a right or a left piece of trim. In certain embodiments, the designation “RIGHT PIECE” or “LEFT PIECE”, as shown in FIG. 2 or otherwise positioned, may be displayed as applicable. In FIG. 9, a bevel angle of 33.6° is displayed. In addition, the angle is graphically depicted on the display screen. As shown in FIG. 10, the arms 12 and 14 of protractor 10 are pivoted as shown and the processor 24 is programmed to reflect the angle between the arms under the designation “SET”. The user pivots arms 12 and 14 relative to one another until the “SET” angle reading matches the bevel angle reading, e.g. 33.6° as reflected in the display shown in FIG. 10. Bevels are always tilted left. Protractor 10 may include a nut, thumbwheel or other tensioning device for tightening the arms together and restricting rotation of arm 14 relative to arm 10.

With the bevel set as shown in FIG. 10, the user employs protractor 10 to quickly and accurately adjust the miter saw in accordance with the calculated bevel angle. As shown in FIG. 11, protractor 10, which is set to a 33.6° bevel angle is engaged with miter saw S. Fixed arm 12 is flushly engaged with an upper surface of table or base T of saw S. The bevel angle of miter saw blade B is adjusted until arm 14 of protractor 10 is flushly engaged with the face of the blade. The magnets carried along the edge of arm 14 secure the arm to blade B. Again, magnets may or may not be used in any of the edges of arms 12 and 14. Accordingly, with protractor 10 set upon table T, blade B is adjusted so that it flushly interengages the edge of arm 14 as shown. This quickly and accurately sets the proper bevel angle of the miter saw.

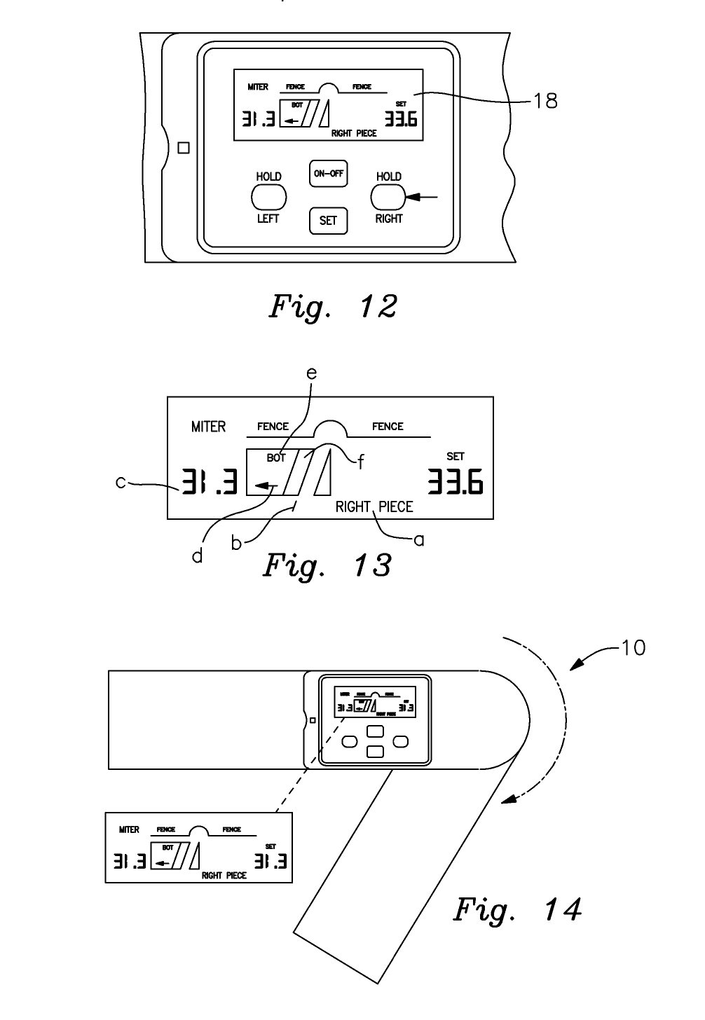

The user next presses either the “HOLD RIGHT” or “HOLD LEFT” button, as applicable, to enter the miter setting mode. An example of the display when pressing the “HOLD RIGHT” button is shown in FIG. 12. The processor calculates the correct miter angle as 31.3° and that amount is displayed on the screen 18. A “RIGHT PIECE” designation is also depicted. Specifically, the graphics on screen 16 also reflect the following information:

(a). how to cut the right piece of trim;
(b). the saw is mitered to the left;
(c). the calculated miter angle is 31.3°;
(d). the trim to keep is to the left of the blade;
(e). the bottom of the trim is placed against the fence; and
(f). the saw is beveled to the left.
See the corresponding designations in the display depicted in FIG. 13.

Upon obtaining the calculated miter reading for a left hand miter of a right piece, the user rotates arm 14 as shown in FIG. 14 until the protractor's SET reading matches the calculated miter reading, i.e. 31.3°. With protractor 10 set in the angular position shown in FIG. 14, it is engaged with the miter saw S, as shown in FIG. 15, to quickly and accurately set the proper miter angle. Specifically, the edge of arm 14 engages the saw and the upper edge of arm 12 engages the fence F. Accordingly, both bevel and miter angles are quickly and accurately set using protractor 10.

After the foregoing steps are completed, they may be repeated in an analogous fashion so that the miter saw is set for properly cutting the left piece of trim as well. Specifically, the user holds the HOLD LEFT button of panel 20 and first performs the bevel set and next performs the miter set in the manner previously described. When the bevel and miter angles are calculated and set, the protractor is then engaged with the miter saw and used to quickly and accurately set the required bevel and miter angles for cutting the left piece.

When the process is completed, the “HOLD LEFT” and “HOLD RIGHT” buttons are pushed simultaneously to push the protractor to the measuring mode.

An alternative crown molding or trim protractor 100 is shown in FIGS. 16-19. Protractor 100 comprises a pair of measuring arms 105 and 108 that are pivotally interconnected by a connection module 101. Measuring arm 105 includes a digital readout unit 103 having a digital display screen 104 and a plurality of operating buttons 112. Readout 103 houses a processing unit 133 that determines bevel and miter angles as described below.

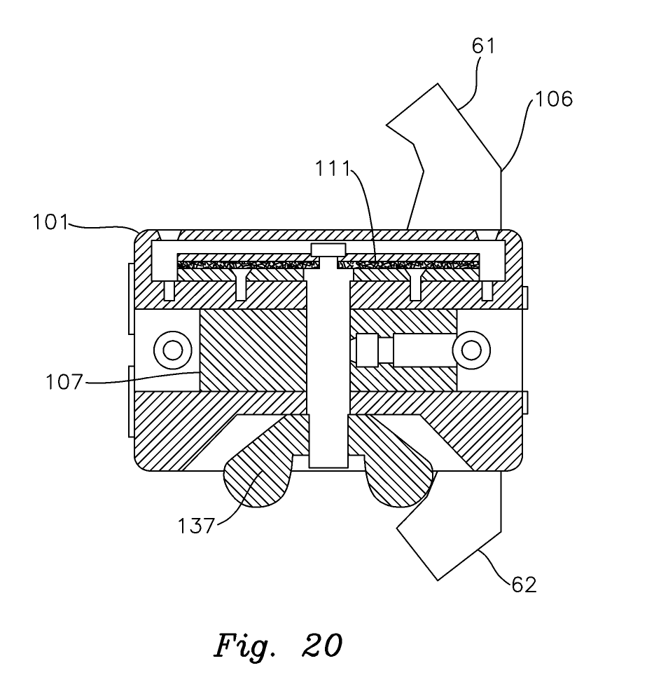

A second measurement arm 108 is connected to a driver connection 107 mounted within connection module 101. A capacitive disk sensor 111, FIG. 20, is operatively attached to drive connection 107 such that when arm 108 pivots, drive connection 107 is rotated and this turns capacitive sensor disk 111 an amount that reflects the degree of angular rotation of arm 108 (relative to arm 105). Capacitor sensor 111 or an alternative type of sensor is operatively connected in a conventional manner to processing electronics mounted within readout 103.

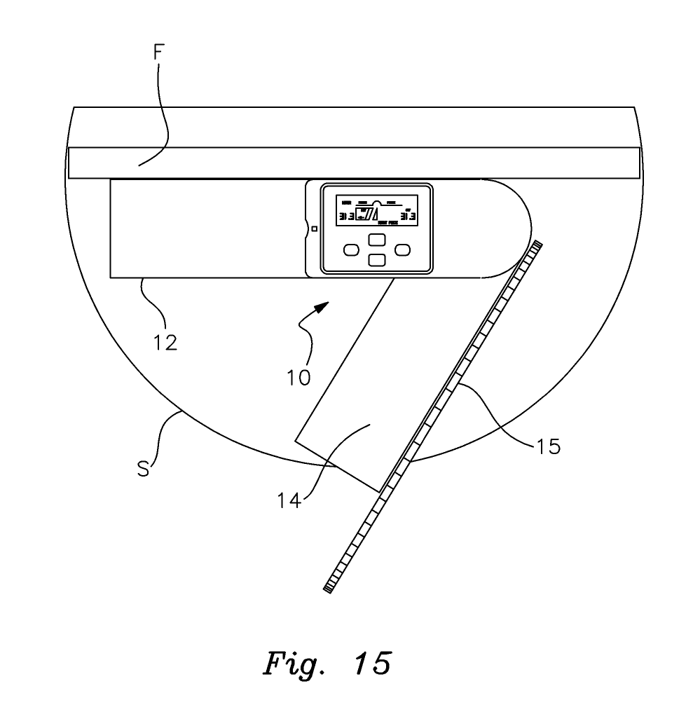

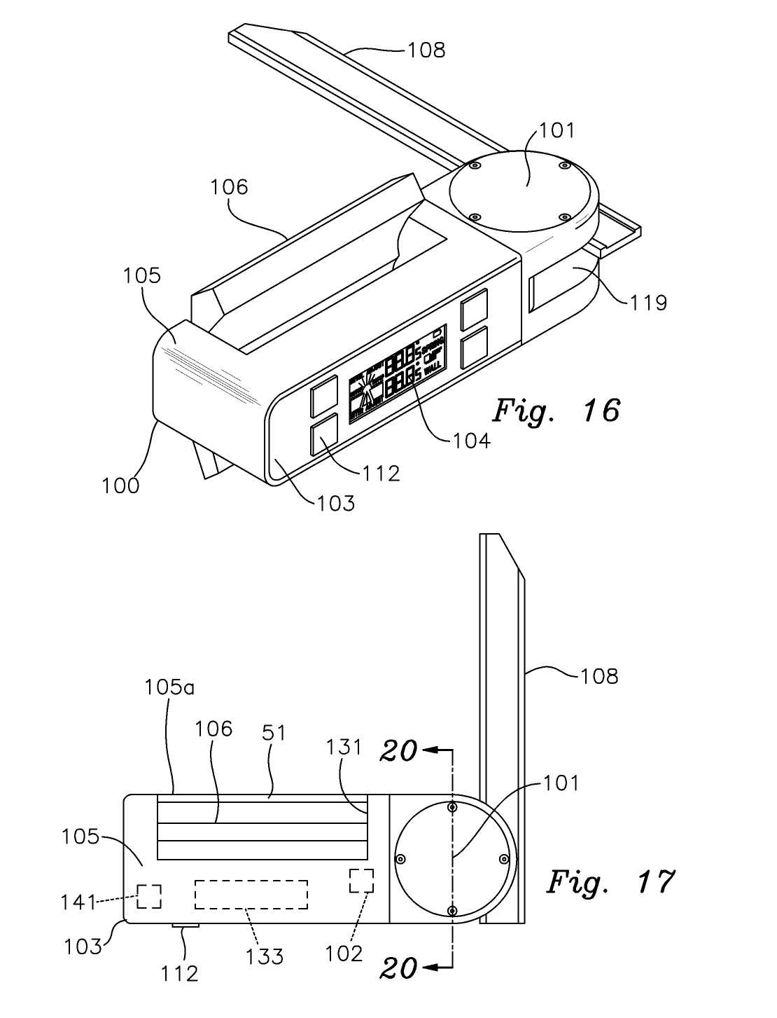

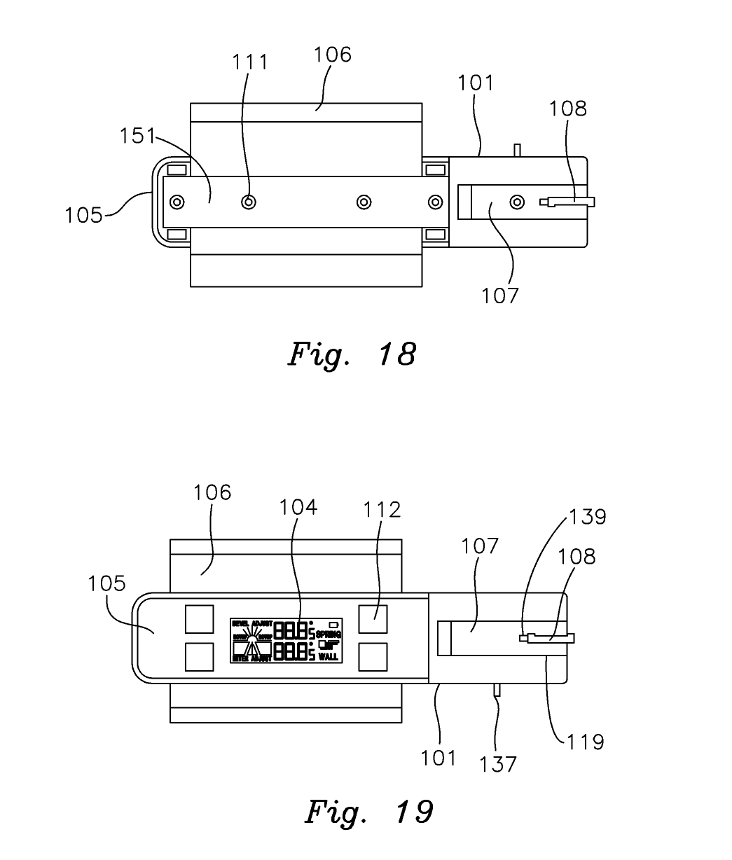

Arm 105 includes a receptacle 131 for receiving a piece of trim or molding 106. Trim 106 is secured by screws 111 to a bracket 151 that extends across recess 131. See FIGS. 17 and 18. To measure the spring angle, a representative piece of trim 116 representing the spring angle to be measured, is attached to bracket 151 and utilized in the manner described below.

Sensor 111 serves as a wall angle measuring sensor. A separate spring angle measuring sensor 102 represented in phantom in FIG. 17, is mounted within the readout unit 103. This sensor typically comprises a gravity acceleration sensor or other type of sensor employing MEMS technology. Sensors of this type will be understood to persons skilled in the art. By the same token, the capacitive disk sensor 111 may alternatively comprise various other types of sensor as are disclosed in U.S. Pat. Nos. '034 and '322, as well as in pending application Ser. No. 14/837,469. Processor 133 is programmed to perform in accordance with known programming techniques to perform the operations described below.

Arm 108 is received in a slot 119 formed in the connecting module 101. Arm 108 includes a pair of longitudinal ribs. At least one of those ribs may be received in a groove formed within driver 107. A wing nut 137, magnetic strip 139 and other means may be used for adjustably securing the rotating arm 108 to the driver. Such means may be selectively loosened to allow arm 108 to slide longitudinally through the connecting module 101 so that various measurements may be taken and facilitated. Nut 137 may be selectively tightened to lock the measuring arm at a selected angle.

When measuring arm 108 rotates, the connection module 101 rotates in a corresponding manner. This, in turn, drives the rotation axis of wall angle sensor 111. By the same token, tilting of arm 105 causes the gravity acceleration sensor 102 to tilt so that a spring angle is measured and sent to the processing unit 133.

Processor 133 calculates miter and bevel angles in accordance with the following equations.

Bevel=arcsin [ cos(wall/2)*cos(spring)]; (1)

Miter=arctan [ cot(wall/2)*sin(spring)]; (2)

The operating panel of readout 103 includes function buttons 112 which power on and off the protractor as described below. A buzzer 141, FIG. 17, which may comprise various forms of audible warning or signaling devices, is mounted within readout 103. It can produce respective sounds when the bevel or miter angle conforms with or falls outside of parameters of the measured spring and/or wall angles. The gravity acceleration sensor 102 may comprise a micro-thermal couple device and may adopt MEMS technology. This sensor typically detects the position of a heated air mass (acceleration position) through the means of a thermocouple to identify the spatial position of the sensor. Such a sensor features the advantages of small size, high reliability and low cost. Silicon micro-thermocouple gravity acceleration sensors are conventionally used in dip angle measuring.

The respective operating buttons 112 may be labeled as follows:
WALL
SPRING
BV/RESET
MTR/RESET
   Referring to FIG. 21, to measure the wall angle a designated, one of the buttons 112 is selected and pressed to choose either an inner angle or an external angle. Arm 108 is then longitudinally adjusted to measure the selected inner wall angle (as shown in FIG. 21) or external wall angle. Arm 108 is rotated so that the inner measuring surface 105a of measurement arm 105 (including, in part, the bracket 106) and one edge of arm 108 respectively fit against and flushly engage the two adjoining walls. Rotating measuring arm 108 rotates drive connection 107. As a result, capacitive angle sensor 111 measures the angular rotation and delivers a corresponding wall angle signal to processor 133. A representative wall angle 155 is then sent to and displayed on display screen 104.

As shown in FIG. 22, spring angle measurement is performed by engaging trim piece 106 with the wall W and ceiling C so that the upper portion of the trim engages ceiling C and a lower portion of the trim flushly engages wall W. This tilts protractor 10 downwardly such that the gravity acceleration sensor 102 measures the degree of tilt or the spring angle 160. The button labeled WALL is initially pressed to record the wall angle. This also switches the readout into the spring measuring mode. The spring angle measurements can then be taken as described above by pressing the button labeled SPRING. The data computing and processing unit 133 records both the spring and wall angles and sends them to the display. Processor 133 then calculates bevel and miter angles in accordance with the previously specified equations. Visualized indications are then provided on display screen 104 for adjusting the miter saw to achieve the required trim or molding cuts.

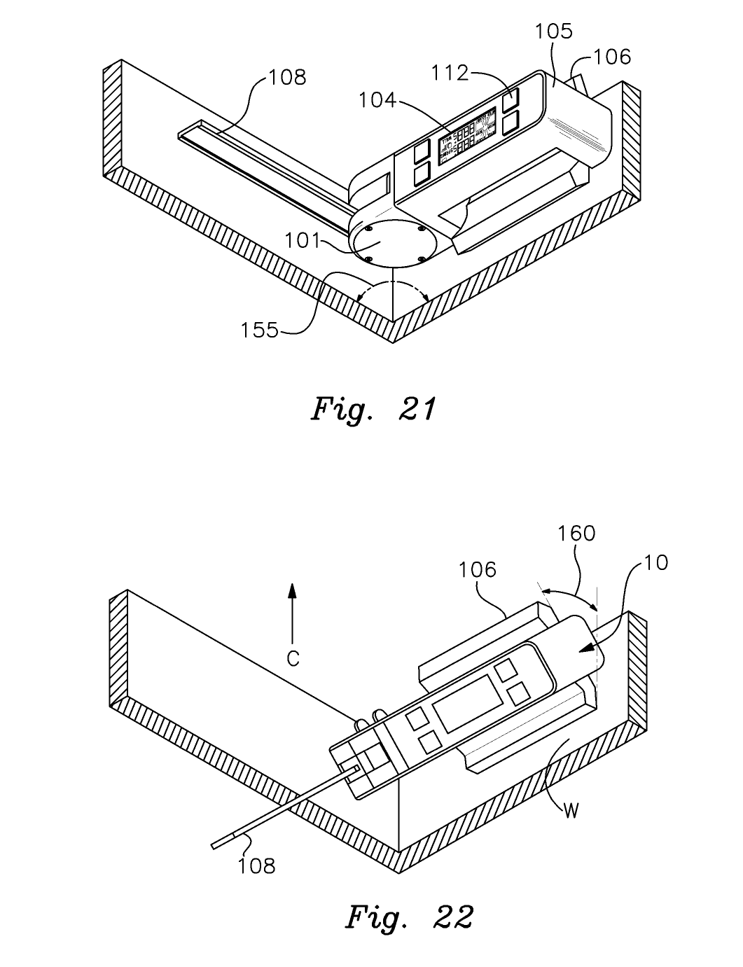

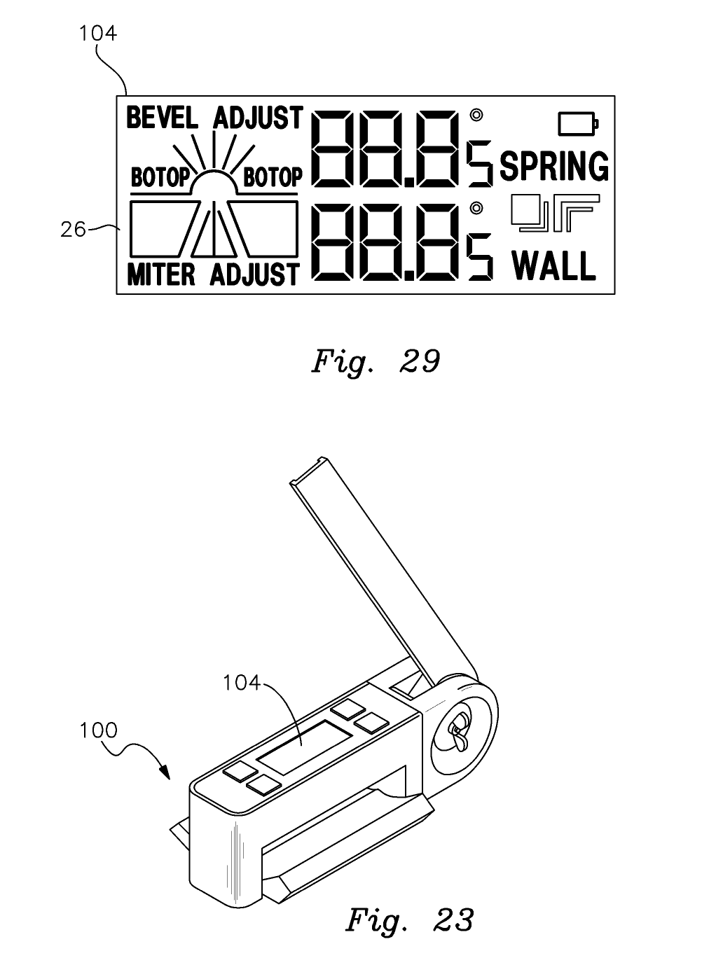

Specifically, to adjust the bevel angle, the user presses the button labeled BVL/RESET, which switches the protractor to the bevel angle adjusting mode. Protractor 100 appears generally as shown for example in FIG. 23. Display 104 appears as shown in FIG. 24. The “ADJUST” value, i.e. the relative angle between measuring arm 108 and the measuring surface 105a of arm 105 is presented at the bottom of display unit 104. On the left top of display unit 104 a red flashing angle indicator 151 synchronically simulates the position of the calculated bevel angle. The user rotates measuring arm 108 to the left or right according to the miter saw. If the difference between the “ADJUST” prompt value and the calculated bevel angle value is within 5°, buzzer 141, FIG. 17, emits a low frequency, low pitched and/or long interval beeping sound. However, if the difference is within 2°, buzzer 141 emits a high frequency, high pitched and/or short interval beeping sound. A continuous sound is produced if the difference is within 0.3°. If the “ADJUST” prompt number equals the bevel angle at the top of the screen, the angle between the two measuring arms is the determined bevel angle. The screw lock nut is then tightened to lock measuring arm 108 in place. Measuring surface 105a of measuring arm 105 is engaged with saw table T1 as shown in FIG. 25. Saw blade B1 may then be adjusted to match the angle of measuring arm 108 in accordance with the flashing red segment 151 on display unit 104. The bevel angle adjustment is thereby completed. If the red indicator on display screen 141 is not flashing, the user will be unable to judge the moving direction of the saw blade exactly, which will result in incorrect adjustment of blade B1. However, when the angle indicator flashes red, the operator is able to accurately judge and adjust the bevel of the miter saw blade. This enables the blade to be adjusted to the correct cutting angle.

The user next proceeds to adjust the miter angle of saw SI. The user momentarily presses the button labeled MTR/RESET, which switches protractor 100 into the miter angle adjusting mode. As shown in FIGS. 26 and 27, the relative angle between measuring arm 108 and the measuring surface 105a of measuring arm 105 is indicated at the top of display screen 104 adjacent the designation “ADJUST”, which represents the determined miter value (e.g. 31.6°). At the bottom left of display 104, a red flashing angle indicator 161 synchronically simulates the proper position of the miter angle calculated by processor 133. If the difference between the ADJUST prompt value and the calculated miter angle value is within 5°, buzzer 141 emits a low frequency or other sound as previously described; if the difference is within 2°, buzzer 141 emits a higher frequency or other sound described above. A continuous sound is again produced if the difference is within 0.3°. As with the bevel adjustment, the user adjusts the angle between arms 108 and 105 until the upper displayed value equals the lower displayed calculated angle (e.g. 31.6° in FIG. 27). Locknut 137 is then tightened to lock measuring arm 108. As shown in FIG. 28, the measuring surface of arm 105 is engaged with fence F1 of platform P1 and the miter saw table notch is adjusted so that it is aligned with the angle of measuring arm 108 and in accordance with the flashing red line 161 and display 104. This completes the miter angle adjustment for cutting saw S. The flashing red indicator allows the user to better judge the rotating direction of the table saw so that improved and more accurate cuts are formed in the trim.

After completing the bevel and miter angle adjustments, display unit 104 graphically indicates the current angle of the miter saw and advises the user which side is more suitable for placing the trim. As shown in FIG. 29, the trim should be placed on the saw table in accordance with graphic indications 26. When the symbol [symbol] is produced the trim should be placed on the left of the saw blade. If the display presents a [symbol] symbol, the corner line should be placed on the right of the saw blade. Display 104 also presents “TOP” or “BOT” to indicate whether the top or bottom side of the trim is to be cut. For example, the graphical view in FIG. 27 indicates that the top of the trim is engaged with the fence when that piece of trim is cut.

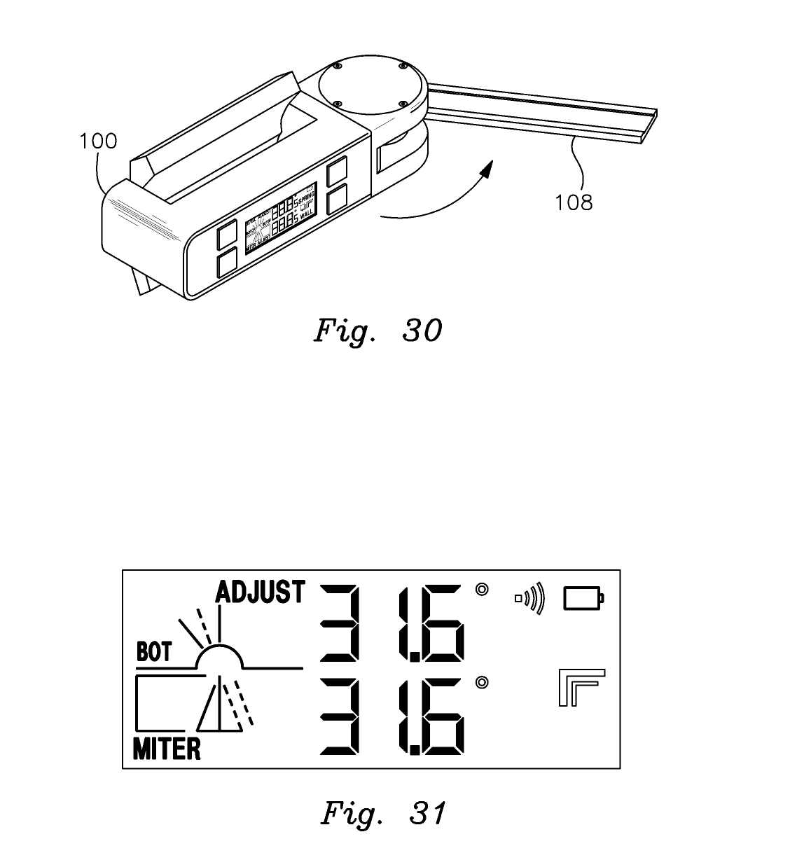

After the user cuts one of the adjoining pieces of trim, he rotates measuring arm 108 in an opposite direction as shown in FIG. 30. As indicated by FIG. 31 the bottom of the trim piece is engaged with the fence. Protractor 100 remains in engagement with saw S, FIG. 31 such that the measuring surface 105a of arm 105 remains engaged against the fence F1. If the measured angle at the top of the display screen equals the bottom angle) (31.6° an indicative sound is emitted by the buzzer. This sets the miter angle for the second piece of trim. The measuring arms 105 and 108 are locked in place and the blade is adjusted so that it flushly engages adjusted arm 108. The miter saw table notch is adjusted to the angle of the measuring arm 108 according to the angle indicator. Display unit 104 again indicates that the bottom side of the second trim piece should engage the fence. A cut is made and the two adjoining pieces form a perfect corner joint ad depicted in FIG. 32.

Utilizing either of the protractors 110 or 100 of this invention, the user can more quickly, accurately and efficiently perform even, neat matching edges in adjoining pieces of trim. The protractor provides intuitive and easy to understand prompts that make the cutting operation virtually full proof. Unlike any previous devices, the protractor itself may be adjusted in accordance with the calculated bevel and miter angles and then directly engaged with the miter saw to more quickly and accurately adjust the saw in order to perform the required trim cuts. Crown molding and other trim installation is therefore facilitated considerably.

Although specific features of the invention are shown in some of the drawings and not others, this is for convenience only, as each of the features may be combined with any and all of the other features in accordance with this invention.

Other embodiments will occur to those skilled in the art and are within the following claims:

What is claimed is:

1. A digital protractor for use in combination with a pair of trim pieces and a miter saw to define and set miter and bevel angles in the miter saw for installing adjoining pieces of trim, said protractor comprising:
a pair of pivotally interconnected arms, each having at least one engagement edge extending longitudinally of said arm;
an electronic sensor secured to one of said arms and a digital readout device secured to the other said arm, said digital readout device including means responsive to said sensor for measuring and displaying spring and wall angles and calculating and displaying bevel and miter angles for the miter saw derived from said measured spring and wall angles and required for the miter saw to cut the trim pieces, said arms being adjusted according to said calculated miter and bevel angles for engaging the miter saw to adjust the bevel and miter angles of the saw.

2. A digital protractor for use in combination with a pair of trim pieces and a miter saw to define and set miter and bevel angles in the miter saw for installing adjoining pieces of trim, said protractor comprising:
a pair of electronic sensors mounted to said pivotally interconnected first and second arms and a digital readout device secured to one of said arms for operatively cooperating with said electronic sensors; said digital readout device including means responsive to said sensors for calculating and displaying spring and wall angles and calculating and displaying bevel and miter angles for the miter saw derived from said calculated spring and wall angles and required for the miter saw to cut the trim pieces, said arms being adjusted according to said calculated miter and bevel angles for engaging the miter saw to adjust the bevel and miter angles of the saw.
